(19) United States
(12) Patent Application Publication
(10) Pub. No.: US 2025/0132086 A1
(43) Pub. Date: Apr. 24, 2025

(54) COIL COMPONENT

(71) Applicant: SAMSUNG ELECTRO-MECHANICS CO., LTD., Suwon-si (KR)

(72) Inventors: Byeong Cheol MOON, Suwon-si (KR); Sang Jin KIM, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/806,003

(22) Filed: Aug. 15, 2024

(30) Foreign Application Priority Data
Oct. 23, 2023 (KR) 10-2023-0141652

(51) Int. Cl. H01F 27/30; H01F 5/04; H01F 27/29

(52) U.S. Cl. CPC H01F 27/306; H01F 5/04; H01F 27/292

(57) ABSTRACT

A coil component includes: a body having a first surface, a second surface opposing the first surface in a first direction, and one or more side surfaces connecting the first and second surfaces to each other; first and second support members disposed to be spaced apart from each other in the first direction inside the body; and a coil portion including first and third coils disposed on both surfaces of the first support member, a first via connecting the first and third coils to each other, second and fourth coils disposed on both surfaces of the second support member, and a second via connecting the second and fourth coils to each other, in which the third coil and the fourth coil are bonded to each other inside the body.

### CROSS-REFERENCE TO RELATED APPLICATION(S)

This application claims benefit of priority to Korean Patent Application No. 10-2023-0141652 filed on Oct. 23, 2023 in the Korean Intellectual Property Office, the disclosure of which is incorporated herein by reference in its entirety.

### TECHNICAL FIELD

The present disclosure relates to a coil component.

An inductor, a coil component, is a representative passive electronic component used in an electronic device together with a resistor and a capacitor.

Currently, demand for inductors in electric vehicles and cloud servers is rapidly increasing worldwide. In such applications, size constraints are not substantial, and thus, a large-sized power inductor is used. Since such a power inductor requires particularly low current characteristics, a structure in which a thickness and a width of a conductor of the inductor are large is often required. Therefore, currently, a winding type power inductor is the most common.

However, a thin film type power inductor using a plating method may not fully utilize an internal space even in a case where an inductor size is large due to a limitation in plating thickness, and may thus be considered inferior to the winding type inductor in terms of implementing high capacity.

### SUMMARY

An aspect of the present disclosure may improve characteristics of a coil component via the methods and structures presented herein.

According to an aspect of the present disclosure, a coil component includes: a body having a first surface, a second surface opposing the first surface in a first direction, and one or more side surfaces connecting the first and second surfaces to each other; first and second support members disposed to be spaced apart from each other in the first direction inside the body; and a coil portion including first and third coils disposed on both surfaces of the first support member, a first via connecting the first and third coils to each other, second and fourth coils disposed on both surfaces of the second support member, and a second via connecting the second and fourth coils to each other, in which the third coil and the fourth coil are bonded to each other inside the body.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic view illustrating a coil component according to a first exemplary embodiment in the present disclosure;

FIG. 2 is a schematic exploded perspective view illustrating first and second support members and a coil portion of FIG. 1;

FIG. 3 is a cross-sectional view taken along line I-I′ of FIG. 1;

FIG. 4 is a cross-sectional view taken along line II-II′ of FIG. 1;

FIG. 5 is an enlarged view of portion A of FIG. 4.

FIG. 6 is a view illustrating a coil component according to a modified example of the first exemplary embodiment in the present disclosure and corresponding to FIG. 4;

FIG. 7 is a cross-sectional view illustrating a coil component according to a second exemplary embodiment in the present disclosure and corresponding to FIG. 4;

FIG. 8 is an enlarged view of portion B of FIG. 7; and

FIG. 9 is a view illustrating a coil component according to a modified example of the second exemplary embodiment in the present disclosure and corresponding to FIG. 4.

### DETAILED DESCRIPTION

Terms used in the present specification are used only in order to describe specific exemplary embodiments rather than limiting the present disclosure. Singular forms are intended to include plural forms unless the context clearly indicates otherwise. It is to be understood that the terms “include” or “have” used here specify the presence of features, numbers, steps, operations, components, portions, or combinations thereof mentioned in the present specification, or combinations thereof, but do not preclude the presence or addition of one or more other features, numbers, steps, operations, components, portions, or combinations thereof. In addition, throughout the specification, “on” does not necessarily mean that any element is positioned on an upper side based on a gravity direction, but means that any element is positioned above or below a target portion.

Further, a term “couple” not only refers to a case where respective components are in physically direct contact with each other, but also refers to a case where the respective components are in contact with another component with another component interposed therebetween, in a contact relationship between the respective components.

Since sizes and thicknesses of the respective components illustrated in the drawings are arbitrarily illustrated for convenience of explanation, the present disclosure is not necessarily limited to those illustrated in the drawings.

In the drawings, an X-direction refers to a first direction or a thickness direction, a Y-direction refers to a second direction or a length direction, and a Z-direction refers to a third direction or a width direction.

Hereinafter, coil components according to exemplary embodiments in the present disclosure will be described in detail with reference to the accompanying drawings. In describing exemplary embodiments in the present disclosure with reference to the accompanying drawings, components that are the same as or correspond to each other will be denoted by the same reference numerals, and an overlapping description thereof will be omitted.

Various kinds of electronic components may be used in electronic devices, and various kinds of coil components may be appropriately used between these electronic components depending on their purposes in order to remove noise, or the like.

That is, the coil components used in the electronic devices may be a power inductor, high frequency (HF) inductors, a general bead, a bead for a high frequency (GHz), a common mode filter, and the like.

### FIRST EXEMPLARY EMBODIMENT

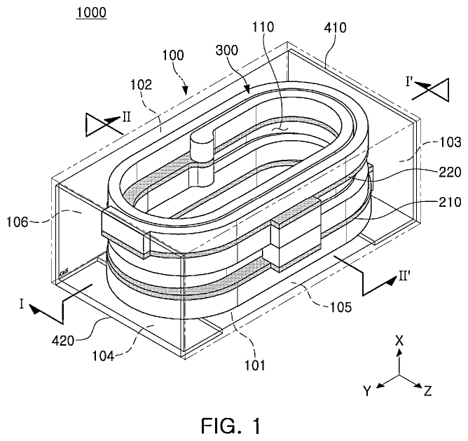

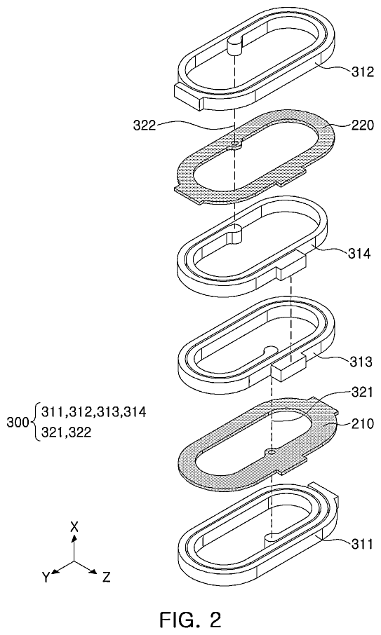

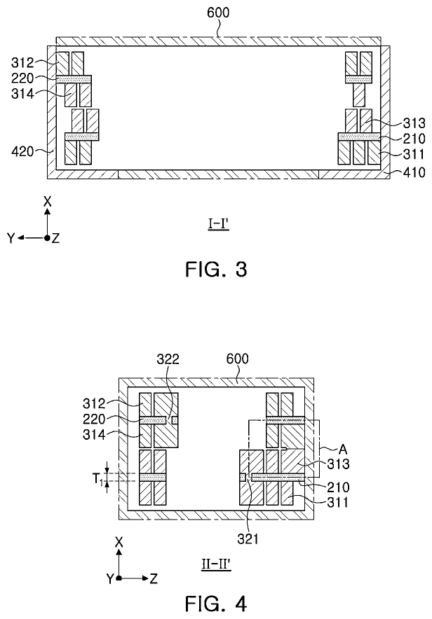

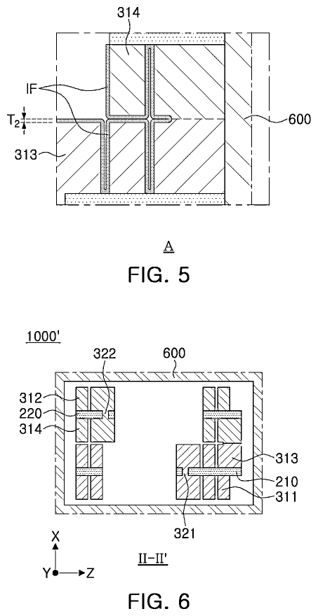

FIG. 1 is a schematic view illustrating a coil component according to a first exemplary embodiment in the present disclosure. FIG. 2 is a schematic exploded perspective view illustrating first and second support members and a coil portion of FIG. 1. FIG. 3 is a cross-sectional view taken along line I-I′ of FIG. 1. FIG. 4 is a cross-sectional view taken along line II-II′ of FIG. 1. FIG. 5 is an enlarged view of portion A of FIG. 4.

Referring to FIGS. 1 through 5, a coil component 1000 according to the first exemplary embodiment in the present disclosure may include a body 100, support members 210 and 220, and a coil portion 300, and may further include external electrodes 410 and 420, an insulating layer 600, and an insulating film IF.

The body 100 may form an appearance of the coil component 1000 according to the present exemplary embodiment, and may embed the support members 210 and 220 and the coil portion 300 therein.

The body 100 may generally have a hexahedral shape.

A first exemplary embodiment in the present disclosure will hereinafter be described on the assumption that the body 100 has the hexahedral shape. However, such a description does not exclude a coil component including a body having a shape other than the hexahedral shape from the scope of the present exemplary embodiment.

Referring to FIG. 1, the body 100 may have a first surface 101 and a second surface 102 opposing each other in the first direction (X-direction), a first side surface 103 and a second side surface 104 opposing each other in the second direction (Y-direction), and a third side surface 105 and a fourth side surface 106 opposing each other in the third direction (Z-direction). The first to fourth side surfaces 103, 104, 105, and 106 of the body 100 may correspond to a plurality of side surfaces of the body 100 that connect the first surface 101 and the second surface 102 of the body 100 to each other.

The body 100 may be formed in such a way that the coil component 1000 according to the present exemplary embodiment in which the external electrodes 410 and 420 described below are formed may have a length of 4.1 mm, a width of 4.1 mm, and a thickness of 1.45 mm by way of example, but is not limited thereto. Meanwhile, the dimensions described above are merely design dimensions that do not reflect process errors and the like, and it is thus to be considered that dimensions within ranges admitted as the processor errors fall within the scope of the present disclosure.

The body 100 may include magnetic materials and a resin. Specifically, the body 100 may be formed by stacking one or more magnetic composite sheets in which the magnetic material is dispersed in the resin. However, the body 100 may also have a structure other than a structure in which the magnetic materials are dispersed in the resin. For example, the body 100 may be formed of a magnetic material such as ferrite or may be formed of a non-magnetic material.

The magnetic material may be ferrite or magnetic metal powder.

The ferrite may be, for example, at least one of spinel type ferrite such as Mg—Zn-based ferrite, Mn—Zn-based ferrite, Mn—Mg-based ferrite, Cu—Zn-based ferrite, Mg—Mn—Sr-based ferrite, or Ni—Zn-based ferrite, hexagonal ferrite such as Ba—Zn-based ferrite, Ba—Mg-based ferrite, Ba—Ni-based ferrite, Ba—Co-based ferrite, or Ba—Ni—Co-based ferrite, garnet type ferrite such as Y-based ferrite, or Li-based ferrite.

The magnetic metal powder may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder may be at least one of pure iron powder, Fe—Si-based alloy powder, Fe—Si—Al-based alloy powder, Fe—Ni-based alloy powder, Fe—Ni—Mo-based alloy powder, Fe—Ni—Mo—Cu-based alloy powder, Fe—Co-based alloy powder, Fe—Ni—Co-based alloy powder, Fe—Cr-based alloy powder, Fe—Cr—Si-based alloy powder, Fe—Si—Cu—Nb-based alloy powder, Fe—Ni—Cr-based alloy powder, or Fe—Cr—Al-based alloy powder.

The magnetic metal powder may be amorphous or crystalline. For example, the magnetic metal powder may be Fe—Si—B—Cr based amorphous alloy powder, but is not necessarily limited thereto.

The magnetic metal powder may have an average diameter of about 0.1 μm to 30 μm, but is not limited thereto.

The body 100 may include two kinds or more of magnetic materials dispersed in the resin. Here, different kinds of magnetic materials mean that the magnetic materials dispersed in the resin are distinguished from each other by any one of an average diameter, a composition, crystallinity, and a shape.

The resin may include epoxy, polyimide, liquid crystal polymer (LCP), or the like, or mixtures thereof, but is not limited thereto.

The body 100 may include a core 110 penetrating through a central portion of each of the support members 210 and 220 and the coil portion 300 described below. The core 110 may be formed by filling a through-hole of the central portion of each of the support members 210 and 220 and the coil portion 300 with the magnetic composite sheets, but is not limited thereto.

The support members 210 and 220 may be disposed inside the body 100 and support the coil portion 300 described below. The support members 210 and 220 may be spaced apart from each other inside the body 100. Specifically, referring to FIGS. 1 and 2, the first support member 210 and the second support member 220 may be disposed parallel to the first surface 101 of the body 100, and may be disposed to be spaced apart from each other in the first direction (Z-direction) of the body 100 inside the body 100. The first support member 210 may be disposed closer to the first surface 101 of the body 100 than the second support member 220. First and third coils 311 and 313 of the coil portion 300 described below are disposed on the first support member 210, and second and fourth coils 312 and 314 of the coil portion 300 described below may be disposed on the second support member 220. A thickness of each of the support members 210 and 220 may be 20 μm or more and 70 μm or less, but is not necessarily limited thereto. As described below, after the coils 311, 312, 313, 314 are formed on the corresponding first and second support members 210 and 220, the support members 210 and 220 on which the coils are formed may be bonded to form one coil component 1000. In some embodiments, the first and second support members 210 and 220 may have substantially the same thickness.

The support members 210 and 220 may be formed of an insulating material including at least one of a thermosetting insulating resin such as an epoxy resin, a thermoplastic insulating resin such as a polyimide resin, or a photosensitive insulating resin or be formed of an insulating material including a reinforcing material such as a glass fiber or an inorganic filler impregnated in such an insulating resin. As an example, the support members 210 and 220 may be formed of an insulating material such as a copper clad laminate (CCL), prepreg (ppg), an Ajinomoto Build-up Film (ABF), FR-4, a Bismaleimide Triazine (BT) resin, or a photoimagable dielectric (PID), but are not limited thereto.

As a material of the inorganic filler, one or more materials selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used.

In a case where the support members 210 and 220 are formed of the insulating material including the reinforcing material, the support members 210 and 220 may provide more excellent rigidity. In a case where the support members 210 and 220 are formed of an insulating material that does not include a glass fiber, the support members 210 and 220 may be advantageous in decreasing the overall thickness of the coil portion 300. In a case where the support members 210 and 220 are formed of the insulating material including the photosensitive insulating resin, the number of processes may be decreased, which may be advantageous in reducing a production cost and forming fine holes.

The coil portion 300 may be embedded in the body 100, and may implement characteristics of the coil component. For example, in a case where the coil component 1000 according to the present exemplary embodiment is utilized as a power inductor, the coil portion 300 may serve to store an electric field as a magnetic field to maintain an output voltage, resulting in stabilization of power of an electronic device.

A structure of the coil portion 300 will be described with reference to FIGS. 2 through 4.

The coil portion 300 may include the plurality of coils 311, 312, 313, and 314 spaced apart from each other, and first and second vias 321 and 322. Specifically, the coil portion 300 may include the first and third coils 311 and 313 disposed on both surfaces of the first support member 210 facing the first surface 101 of the body 100, the first via 321 connecting the first and third coils 311 and 313 to each other, the second and fourth coils 312 and 314 disposed on both surfaces of the second support member 220 facing the second surface 102 of the body 100, and the second via 322 connecting the second and fourth coils 312 and 314 to each other.

Each of the plurality of coils 311, 312, 313, and 314 may have a thickness of 175 μm or more. The total thickness of the first to fourth coils may be 700 μm or more, and the first to fourth coils form a single coil. Therefore, a limitation in plating thickness in a coil component according to the related art may be overcome. However, the thicknesses of the plurality of coils are not necessarily limited thereto.

The first and third coils 311 and 313 may be disposed on both surfaces of the first support member 210, respectively. Specifically, the first coil 311 may be disposed on one surface (a lower surface in FIGS. 1 and 2) of the first support member 210, and the third coil 313 may be disposed on the other surface of the first support member 210 (an upper surface in FIGS. 1 and 2). An inner end portion of each of the first coil 311 and the third coil 313 may be in contact with and connected to the first via 321. An outer end portion of the first coil 311 may extend to the first side surface 103 of the body 100 and be connected to the first external electrode 410 described below.

The second and fourth coils 312 and 314 may be disposed on both surfaces of the second support member 220, respectively. Specifically, the second coil 312 may be disposed on one surface (an upper surface in FIGS. 1 and 2) of the second support member 220, and the fourth coil 314 may be disposed on the other surface of the second support member 220 (a lower surface in FIGS. 1 and 2). An inner end portion of each of the second coil 312 and the fourth coil 314 may be in contact with and connected to the second via 322. An outer end portion of the second coil 312 may extend to the second side surface 104 of the body 100 and be connected to the second external electrode 420 described below.

Further, outer end portions of the third and fourth coils 313 and 314 are bonded to each other inside the body 100. As a result, the first to fourth coils 311 to 314 may be connected in series between the first and second external electrodes 410 and 420, so that the coil portion 300 may function as a single coil. Here, the expression “inside the body” does not exclude a case where the coils are bonded on the surface of the body. As an example, the coils may be bonded inside the body, and the bonded surface may extend (be exposed) to the surface of the body.

The outer end portions of the third and fourth coils 313 and 314 may have different shapes from those of the inner end portions of the third and fourth coils 313 and 314. Specifically, the outer end portions of the third and fourth coils 313 and 314 may each have a straight shape protruding toward the third side surface 105 of the body 100. In a case where the outer end portions of the third and fourth coils 313 and 314 each has such a straight shape, direct contact between the third and fourth coils 313 and 314 described below may become easy.

In contrast, the inner end portions of the third and fourth coils 313 and 314 may each have a rounded shape, which may be similar a via pad, for connection to the vias 321 and 322.

The bonding structure will be described in detail with reference to FIG. 5. At least a portion of the outer end portion of the third coil 313 may be connected to at least a portion of the outer end portion of the fourth coil 314 inside the body 100. The third coil 313 and the fourth coil 314 may be in direct contact with each other through resistance welding, laser welding, copper-to-copper direct bonding, or the like. In the above-mentioned methods, the third and fourth coils 313 and 314 may be partially melted and then solidified, so that the third and fourth coils 313 and 134 may be directly connected to each other. However, the connection of the third and fourth coils 313 and 314 is not necessarily limited thereto. According to a second exemplary embodiment described below, third and fourth coils 313 and 314 may be connected by a connection portion 500.

Here, the outer end portion of the coil may refer to a region including a tip of the coil. Therefore, the direct connection of the “outer end portion” may not necessarily imply only the connection of the tip of the coil. As an example, the connection of the coil may be made not only at the tip but also at least a portion of a region corresponding to the outer end portion.

That is, the coil component according to the present exemplary embodiment may be designed in such a way that the third and fourth coils 313 and 314 formed on different support members are in direct contact with each other without using a complex via structure according to the related art, so that a multilayer coil structure with no defect may be implemented with a simple process.

In a coil structure including multiple layers of coil patterns according to the related art, at least two or more coil patterns and at least one insulating layer are alternately formed on one surface of a single support member. In this case, it is difficult to achieve a stable plating height, and thus, there is a limit in increasing a thickness of the coil pattern. In addition, it has been difficult to achieve alignment between the coil pattern formed relatively closer to one surface of the support member and the coil pattern formed relatively farther from one surface of the support member.

In the present exemplary embodiment, the third coil and the fourth coil are bonded by welding or the like after forming the first support member 210 on which the first and third coils are formed and the second support member 220 on which the second and fourth coils are formed. A coil component with a large coil thickness may be manufactured by the methods described herein.

In the present exemplary embodiment, a process of forming at least one insulating layer on one surface of the support member and a process of forming the coil pattern on the insulating layer may be omitted, the processes being required in the multilayer coil structure according to the related art. Therefore, defects caused by misalignment between the coil patterns may be reduced.

Further, in the present exemplary embodiment, the via pad and via structure according to the related art are not used to connect the adjacent intermediate coils 313 and 314 to each other. Instead, the outer end portions of the third and fourth coils 313 and 314 may be bonded to each other inside the body 100, thereby implementing a multilayer coil structure by a simpler process.

The outer end portions of the third and fourth coils 313 and 314 may extend only to one of the third side surface 105 and the fourth side surface 106 opposing each other in the third direction of the body 100. Referring to FIG. 1, the outer end portions of the third and fourth coils 313 and 314 may extend to the third side surface 105. However, the extension of the outer end portions of the third and fourth coils 313 and 314 is not necessarily limited thereto, and the outer end portions of the third and fourth coils 313 and 314 may not extend to the third side surface 105 and the fourth side surface 106 as in a modified example described below.

The body 100 may not be disposed between the third and fourth coils 313 and 314. Magnetic metal powder and a resin may not be disposed in a region where the third and fourth coils 313 and 314 overlap each other between the third and fourth coils 313 and 314. As described below, in some embodiments, only the coil insulating film IF may be disposed in the region where the third and fourth coils 313 and 314 overlap each other, and the body 100 may not be disposed in the region. Here, “overlapping” may mean overlapping in the first direction (X-direction) when viewed from the first direction.

However, the body 100 may be disposed in a region where the third and fourth coils 313 and 314 do not overlap each other. For example, a portion of the body 100 may be disposed between adjacent turns of the third and fourth coils 313 and 314.

The first via 321 may penetrate through the first support member 210 and connect the inner end portions of the first and third coils 311 and 313 to each other. Similarly, the second via 322 may penetrate through the second support member 220 and connect the inner end portions of the second and fourth coils 312 and 314 to each other.

Each of the first to fourth coils 311 to 314 may have a planar spiral shape forming at least one turn around the core 110 of the body 100.

Each of the first to fourth coils 311 to 314 and the first and second vias 321 and 322 may be formed of a conductive material such as copper (Cu), aluminum (Al), silver (Ag), tin (Sn), gold (Au), nickel (Ni), lead (Pb), titanium (Ti), molybdenum (Mo), or alloys thereof, but is not limited thereto.

At least one of the first to fourth coils 311 to 314 and the first and second vias 321 and 322 may include at least one conductive layer. As an example, in a case where the third coil 313 and the first via 321 are formed by plating, each of the third coil 313 and the first via 321 may include a seed layer formed by electroless plating or vapor deposition such as sputtering, and an electroplating layer. Here, the electroplating layer may have a single-layer structure or have a multilayer structure. The electroplating layer having the multilayer structure may be formed in a conformal film structure in which another electroplating layer covers any one electroplating layer, or may be formed to have a shape in which another electroplating layer is stacked on only one surface of any one electroplating layer.

The seed layer of the third coil 313 and the seed layer of the first via 321 may be formed integrally with each other, so that a boundary therebetween is not formed. However, the seed layer of the third coil 313 and the seed layer of the first via 321 are not limited thereto. The electroplating layer of the third coil 313 and the electroplating layer of the first via 321 may be formed integrally with each other, so that a boundary therebetween is not formed. However, the electroplating layer of the third coil 313 and the electroplating layer of the first via 321 are not limited thereto.

The first and second external electrodes 410 and 420 may be disposed to be spaced apart from each other on the body 100, and may be connected to the coil portion 300. Specifically, the first external electrode 410 may be disposed on the first side surface 103 of the body 100 and be in contact with the outer end portion of the first coil 311 exposed to the first side surface 103 of the body 100. Specifically, the second external electrode 420 may be disposed to be spaced apart from the first external electrode 410 on the second side surface 104 of the body 100 and be in contact with and connected to the outer end portion of the second coil 312 exposed to the second side surface 104 of the body 100.

The first and second external electrodes 410 and 420 may extend onto the first surface 101 of the body 100. That is, the first and second external electrodes 410 and 420 may each have an “L” shape.

The external electrodes 410 and 420 may include a plurality of layers. The plurality of layers may be formed by applying and curing a conductive resin containing conductive powder, or may be formed by a vapor deposition method such as sputtering, an electroless plating method, or an electroplating method. As an example, the first external electrode 410 may include a first conductive layer containing copper (Cu), and a second conductive layer disposed on the first conductive layer. The first conductive layer may be formed by applying the insulating layer 600 (described later) to a region other than a region where the external electrodes 410 and 420 are to be formed on the surface of the body 100, and then performing plating using the insulating layer 600 as a plating resist. Alternatively, the first conductive layer may be formed by applying and then curing a curable conductive paste including conductive powder of at least one or copper (Cu) or silver (Ag), and an insulating resin. The second conductive layer may have a double-layer structure of a metal layer containing nickel and a metal layer containing tin.

The external electrodes 410 and 420 may be formed of a conductive material such as copper (Cu), aluminum (Al), silver (Ag), tin (Sn), gold (Au), nickel (Ni), lead (Pb), titanium (Ti), or alloys thereof, but are not limited thereto.

The coil component 1000 according to the first exemplary embodiment in the present disclosure may further include the insulating layer 600 disposed on an outer surface of the body 100. The insulating layer 600 may be formed on the first surface 101, the second surface 102, and the plurality of side surfaces of the body 100. The insulating layer 600 may be disposed on the surface of the body 100 on which the external electrodes 410 and 420 are not formed and may function to electrically protect the coil component, reduce a leakage current, and prevent plating spreading when forming the external electrodes.

The insulating layer 600 may include a thermoplastic resin such as polystyrenes, vinyl acetates, polyesters, polyethylenes, polypropylenes, polyamides, rubbers, or acryls, a thermosetting resin such as phenols, epoxies, urethanes, melamines, or alkyds, a photosensitive resin, parylene, SiOₓ, or SiNₓ.

The insulating layer 600 may be in contact with the outer end portions of the third and fourth coils 313 and 314. As described above, the outer end portions of the third and fourth coils 313 and 314 may extend to the third side surface 105 of the body 100 and may thus be in contact with the insulating layer 600 disposed on the third side surface 105.

The coil component 1000 according to the first exemplary embodiment in the present disclosure may further include the insulating film IF. The insulating film IF may be formed on the support members 210 and 220, and the coil portion 300. Specifically, the insulating film IF may be disposed on each of the first to fourth coils 311 to 314. The insulating film IF may be provided to insulate the coil portion 300 from the body 100, and may include any known insulating material such as parylene. The insulating material included in the insulating film IF is not particularly limited, but may be any insulating material. The insulating film IF may be formed by a method such as vapor deposition, but is not limited thereto, and may be formed by stacking insulation films on both surfaces of the support members 210 and 220. In the former case, the insulating film IF may be formed in the form of a conformal film along the surfaces of the support members 210 and 220 and the coil portion 300.

The insulating films IF disposed on the third and fourth coils 313 and 314 may be in direct contact with each other. The body 100 may not be disposed between the insulating film of the third coil 313 and the insulating film of the fourth coil 314 that are in contact with each other. That is, as described above, the third and fourth coils 313 and 314 may be bonded to each other inside the body 100. Therefore, only the insulating films IF may be disposed between the third and fourth coils 313 and 314 overlapping in the first direction (X-direction).

Referring to FIG. 5, the insulating film IF may be in the form of a conformal film along the surface of the coil. That is, the insulating film IF may cover an upper surface and a side surface of the coil. Further, a portion of the body 100 may fill between adjacent turns of the coil. However, the insulating film IF is not limited thereto. The insulating film IF may be in the form of a partition wall that fills between the coils, and the body 100 may not fill between adjacent turns of the coil.

The insulating film IF may not be disposed in regions of the third coil 313 and the fourth coil 314 bonded to each other inside the body 100. That is, the third and fourth coils 313 and 314 may be bonded to each other through the above-described process after partially removing the insulating film IF from the regions to be bonded of the third and fourth coils 313 and 314.

A thickness of the insulating film IF may be less than 15 μm, but is not necessarily limited thereto. The insulating film IF may have a smaller thickness than those of the above-described support members 210 and 220.

As described above, the thicknesses of the support members 210 and 220 may be 20 μm or more and 70 μm or less, and T₁>2T₂, in which the thickness of the first support member 210 is T₁ and the thickness of the insulating film IF is T₂. In a case where the thickness of the insulating film IF exceeds 10 μm, the thicknesses of the support members 210 and 220 may also be appropriately adjusted to satisfy the above relationship.

The thicknesses of the insulating film IF and the support members 210 and 220 may be measured by the following method. First, the coil component may be polished to a depth of about ½ in the second direction (Y-direction) to prepare a cross-sectional sample. Next, when observing the collected cross-sectional sample with an optical microscope or the like, the insulating film IF and the support members 210 and 220 may be observed, and the thicknesses of the insulating film IF and the support members 210 and 220 may be obtained by measuring lengths in the first direction (X-direction).

Since the insulating film IF has a relatively smaller thickness than those of the support members 210 and 220, a distance between the first and third coils 311 and 313 may be larger than a distance between the third and fourth coils 313 and 314.

A coil component 1000′ according to the modified example of the first exemplary embodiment in the present disclosure will be described with reference to FIG. 6.

FIG. 6 is a view illustrating the coil component according to the modified example of the first exemplary embodiment in the present disclosure and corresponding to FIG. 4.

The modified example is different from the above-described first exemplary embodiment in that third and fourth coils 313 and 314 may not extend to third and fourth side surfaces 105 and 106 of a body 100. That is, outer end portions of the third and fourth coils 313 and 314 may be directed only to one of the third and fourth side surfaces 105 and 106 opposing each other in a third direction of the body, and may not extend to the third and fourth side surfaces 105 and 106. The outer end portions of the third and fourth coils 313 and 314 may be spaced apart from the third and fourth side surfaces 105 and 106. Accordingly, a space may be formed between the outer end portions of the third and fourth coils 313 and 314 and an insulating layer 600, and a portion of the body 100 may be disposed in the space.

Referring to FIG. 6, the outer end portions of the third and fourth coils 313 and 314 may not extend to the third side surface 105 of the body 100. A portion of the body 100 may be disposed between the outer end portions of the third and fourth coils 313 and 314 and the insulating layer 600.

### SECOND EXEMPLARY EMBODIMENT

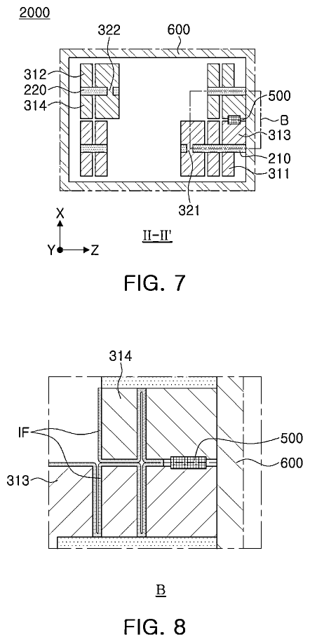

FIG. 7 is a cross-sectional view illustrating a coil component according to the second exemplary embodiment in the present disclosure and corresponding to FIG. 4. FIG. 8 is an enlarged view of portion B of FIG. 7.

A coil component 2000 according to the second exemplary embodiment in the present disclosure may be different from that of the first exemplary embodiment in that the coil component 200 may further include the connection portion 500. Specifically, the connection portion 500 may be disposed between third and fourth coils 313 and 314 and connect at least a portion of an outer end portion of the third coil 313 and at least a portion of an outer end portion of the fourth coil 314 to each other. The connection portion 500 may be disposed inside a body 100. As described above in the first exemplary embodiment, the outer end portion of the coil may refer to a region including a tip of the coil. Therefore, the direct connection of the “outer end portion” may not necessarily imply only the connection of the tip of the coil. As an example, the connection of the coil may be made not only at the tip but also at least a portion of a region corresponding to the outer end portion.

The connection portion 500 may be implemented by a solder and may contain one or more selected from the group consisting of tin (Sn), lead (Pb), copper (Cu), and silver (Ag). That is, the third and fourth coils 313 and 314 may be connected to each other by a solder.

That is, in the coil component according to the second exemplary embodiment, the third coil 313 and the fourth coil 314 are bonded to each other by a solder, and thus, a material different from the third and fourth coils 313 and 314 may be interposed between the third coil 313 and the fourth coil 314.

The connection portion 500 may not extend to a third side surface 105 of the body 100.

As for the remaining configuration of the second exemplary embodiment, the description in the first exemplary embodiment described above may be applied as it is, and a detailed description is redundant and will be omitted below.

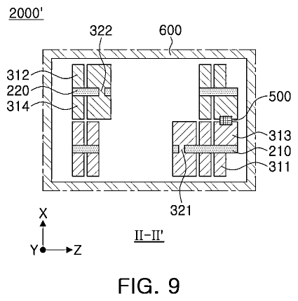

FIG. 9 is a view illustrating a coil component 2000′ according to a modified example of the second exemplary embodiment in the present disclosure and corresponding to FIG. 4. In the modified example, third and fourth coils 313 and 314 may not extend to third and fourth side surfaces 105 and 106 of a body 100, similarly to the above-described modified example (1000′) of the first exemplary embodiment. That is, outer end portions of the third and fourth coils 313 and 314 may extend only to one of the third and fourth side surfaces 105 and 106 opposing each other in a third direction of the body, and may not extend to the third and fourth side surfaces 105 and 106. Accordingly, a space may be formed between the outer end portions of the third and fourth coils 313 and 314 and an insulating layer 600, and a portion of the body 100 may be disposed in the space.

Referring to FIG. 9, the outer end portions of the third and fourth coils 313 and 314 may not extend to the third side surface 105 of the body 100. A portion of the body 100 may be disposed between the outer end portions of the third and fourth coils 313 and 314 and the insulating layer 600.

As set forth above, according to an exemplary embodiment in the present disclosure, characteristics of the coil component may be improved by using a relatively simple method.

While example embodiments have been shown and described above, it will be apparent to those skilled in the art that modifications and variations could be made without departing from the scope of the present invention as defined by the appended claims.

What is claimed is:

1. A coil component comprising:
a body having a first surface, a second surface opposing the first surface in a first direction, and first to fourth side surfaces connecting the first and second surfaces to each other;
first and second support members spaced apart from each other in the first direction inside the body; and
a coil portion including first and third coils disposed on opposed upper and lower surfaces of the first support member, a first via connecting the first and third coils to each other, second and fourth coils disposed on opposed upper and lower surfaces of the second support member, and a second via connecting the second and fourth coils to each other,
wherein the third coil and the fourth coil are bonded to each other inside the body.

2. The coil component according to claim 1, wherein outer end portions of the first and second coils extend to the first and second side surfaces opposing each other in a second direction of the body, respectively.

3. The coil component according to claim 1, wherein outer end portions of the third and fourth coils extend only to one of the third and fourth side surfaces opposing each other in a third direction of the body.

4. The coil component according to claim 1, wherein outer end portions of the third and fourth coils are directed only to one of the third and fourth side surfaces opposing each other in a third direction of the body, and
the outer end portions of the third and fourth coils are spaced apart from the third and fourth side surfaces.

5. The coil component according to claim 1, wherein at least a portion of an outer end portion of the third coil is connected to at least a portion of an outer end portion of the fourth coil inside the body.

6. The coil component according to claim 1, further comprising a connection portion disposed between the third and fourth coils and connecting at least a portion of an outer end portion of the third coil and at least a portion of an outer end portion of the fourth coil,
wherein the connection portion is disposed inside the body.

7. The coil component according to claim 6, wherein the connection portion contains one or more metals selected from the group consisting of tin (Sn), lead (Pb), copper (Cu), and silver (Ag).

8. The coil component according to claim 1, wherein the body includes magnetic metal powder and a resin, and
Wherein the magnetic metal powder and the resin are not disposed in a region where the third and fourth coils overlap each other between the third and fourth coils.

9. The coil component according to claim 1, further comprising an insulating film disposed on each of the first to fourth coils,
wherein the insulating film disposed on the third coil and the insulating film disposed on the fourth coil are in direct contact with each other.

10. The coil component according to claim 9, wherein the insulating film is disposed along surfaces of the first to fourth coils.

11. The coil component according to claim 9, wherein the insulating film is not disposed in regions where the third and fourth coils are bonded to each other inside the body.

12. The coil component according to claim 3, further comprising an insulating layer disposed on an outer surface of the body,
wherein the insulating layer is in contact with the third and fourth coils.

13. The coil component according to claim 1, wherein a distance between the first and third coils is larger than a distance between the third and fourth coils.

14. The coil component according to claim 9, wherein T₁>2T₂ in which a thickness of the first support member is T₁, and a thickness of the insulating film is T₂.

15. The coil component according to claim 1, wherein the first via penetrates through the first support member and is connected to an inner end portion of each of the first and third coils, and
the second via penetrates through the second support member and is connected to an inner end portion of each of the second and fourth coils.

16. The coil component according to claim 1, further comprising:
a first external electrode connected to an outer end portion of the first coil; and
a second external electrode connected to an outer end portion of the second coil,
wherein the first and second external electrodes are disposed on the first and second side surfaces opposing each other in a second direction of the body, respectively.
